(19) United States
(12) Patent Application Publication
(10) Pub. No.: US 2026/0011316 A1
(43) Pub. Date: Jan. 8, 2026

(54) Hand Drum

(71) Applicant: Stephan Bradley Rude, Greeley, CO (US)

(72) Inventor: Stephan Bradley Rude, Greeley, CO (US)

(21) Appl. No.: 19/258,155

(22) Filed: Jul. 2, 2025

Related U.S. Application Data
(60) Provisional application No. 63/667,444, filed on Jul. 3, 2024.

(51) Int. Cl. G10D 13/02; G10D 13/18; G10D 13/20; G10D 13/22; G10D 13/24

(52) U.S. Cl. CPC G10D 13/02; G10D 13/18; G10D 13/20; G10D 13/22; G10D 13/24

(57) ABSTRACT

An acoustic drum and methods of making and using the same, whereby the drum includes a shell having a shell depth extending between a shell upper end and an opposing shell lower end, whereby the shell depth can be not less than about 14 inches; a top head coupled to the shell upper end, whereby the top head comprises wood; a bottom head coupled to the shell lower end; and at least one snare wire operably coupled to the bottom head.

### I. SUMMARY OF THE INVENTION

A broad object of a particular embodiment of the present invention can be to provide an acoustic drum and methods of making and using the same, whereby the drum includes a shell having a shell depth extending between a shell upper end and an opposing shell lower end, whereby the shell depth can be not less than about 14 inches; a top head coupled to the shell upper end, whereby the top head comprises wood; a bottom head coupled to the shell lower end; and at least one snare wire operably coupled to the bottom head.

Naturally, further objects of the invention are disclosed throughout other areas of the specification, drawings, and claims.

### II. A BRIEF DESCRIPTION OF THE DRAWINGS

FIG. 1A is a perspective view of a particular embodiment of the inventive drum.

FIG. 1B is a front view of the drum shown in FIG. 1A.

FIG. 1C is a rear view of the drum shown in FIG. 1A.

FIG. 1D is a first side view of the drum shown in FIG. 1A.

FIG. 1E is a second side view of the drum shown in FIG. 1A.

FIG. 1F is a top view of the drum shown in FIG. 1A.

FIG. 1G is a bottom view of the drum shown in FIG. 1A.

FIG. 1H is a cross-sectional view of the drum shown in FIG. 1B.

FIG. 2 is an exploded perspective view of a particular embodiment of the inventive drum.

FIG. 3 is an exploded perspective view of a particular embodiment of the inventive drum showing sound modifiers.

FIG. 4A is a perspective view of a particular embodiment of the inventive drum showing sound ports.

FIG. 4B is a perspective view of a particular embodiment of the inventive drum showing sound ports.

FIG. 5A shows a frequency response curve for an embodiment of the inventive drum, whereby frequency in Hertz (Hz) is on the x-axis and intensity or loudness of sound in decibels (dB) is on the y-axis.

FIG. 5B shows a frequency response curve for a conventional snare drum, whereby frequency in Hz is on the x-axis and intensity or loudness of sound in dB is on the y-axis.

FIG. 6A shows a frequency response curve for an embodiment of the inventive drum, whereby frequency in Hz is on the x-axis and intensity or loudness of sound in dB is on the y-axis.

FIG. 6B shows a frequency response curve for a conventional snare drum, whereby frequency in Hz is on the x-axis and intensity or loudness of sound in dB is on the y-axis.

FIG. 7A shows a frequency response curve for an embodiment of the inventive drum, whereby frequency in Hz is on the x-axis and intensity or loudness of sound in dB is on the y-axis.

FIG. 7B shows a frequency response curve for a conventional snare drum, whereby frequency in Hz is on the x-axis and intensity or loudness of sound in dB is on the y-axis.

FIG. 8A shows a frequency response curve for an embodiment of the inventive drum, whereby frequency in Hz is on the x-axis and intensity or loudness of sound in dB is on the y-axis.

FIG. 8B shows a frequency response curve for a conventional snare drum, whereby frequency in Hz is on the x-axis and intensity or loudness of sound in dB is on the y-axis.

FIG. 9A shows a frequency response curve for an embodiment of the inventive drum, whereby frequency in Hz is on the x-axis and intensity or loudness of sound in dB is on the y-axis.

FIG. 9B shows a frequency response curve for a conventional snare drum, whereby frequency in Hz is on the x-axis and intensity or loudness of sound in dB is on the y-axis.

FIG. 10A shows a frequency response curve for an embodiment of the inventive drum, whereby frequency in Hz is on the x-axis and intensity or loudness of sound in dB is on the y-axis.

FIG. 10B shows a frequency response curve for a conventional snare drum, whereby frequency in Hz is on the x-axis and intensity or loudness of sound in dB is on the y-axis.

### III. DETAILED DESCRIPTION OF THE PREFERRED EMBODIMENTS

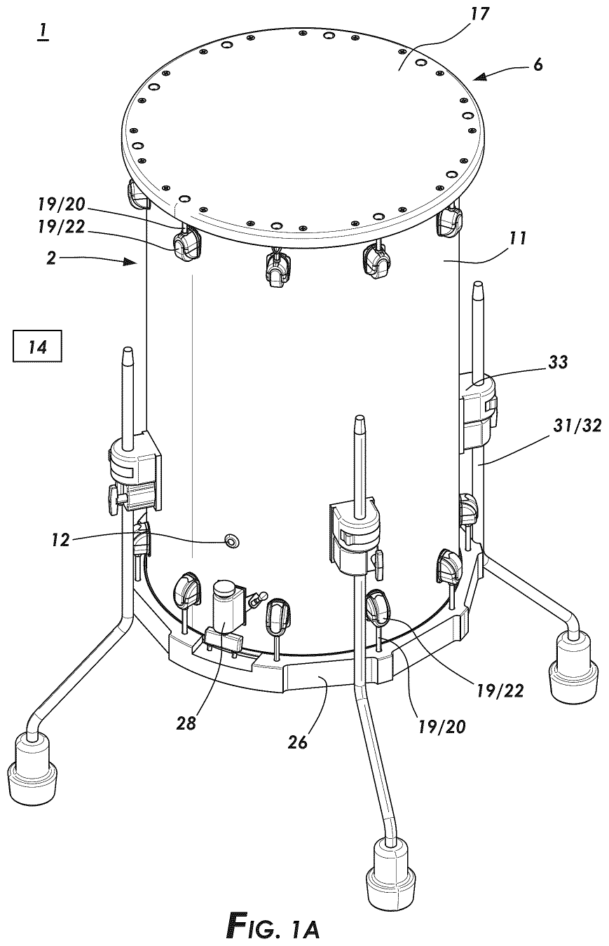

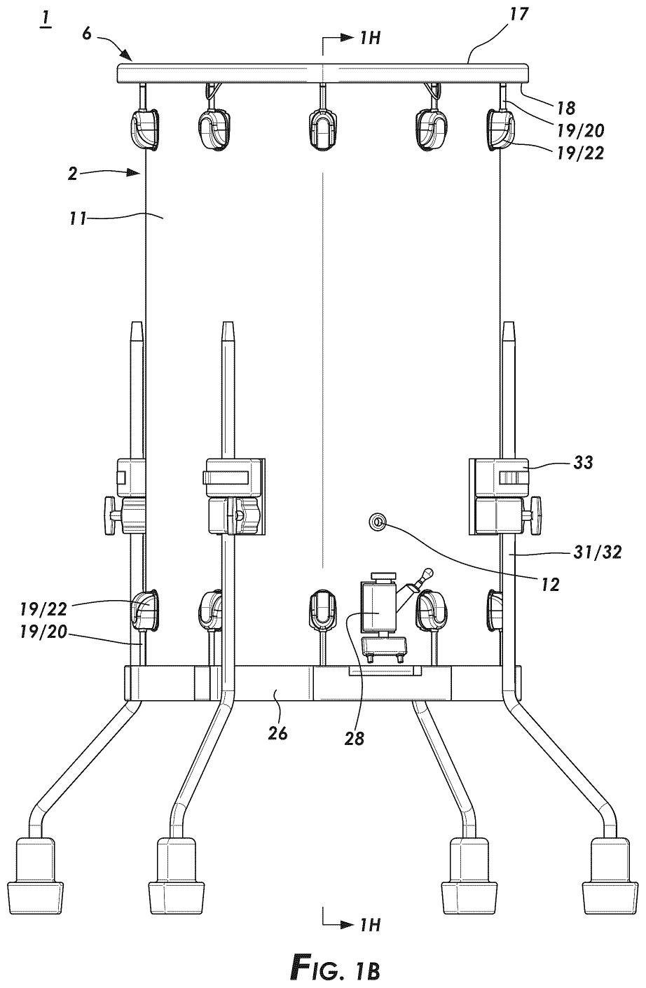

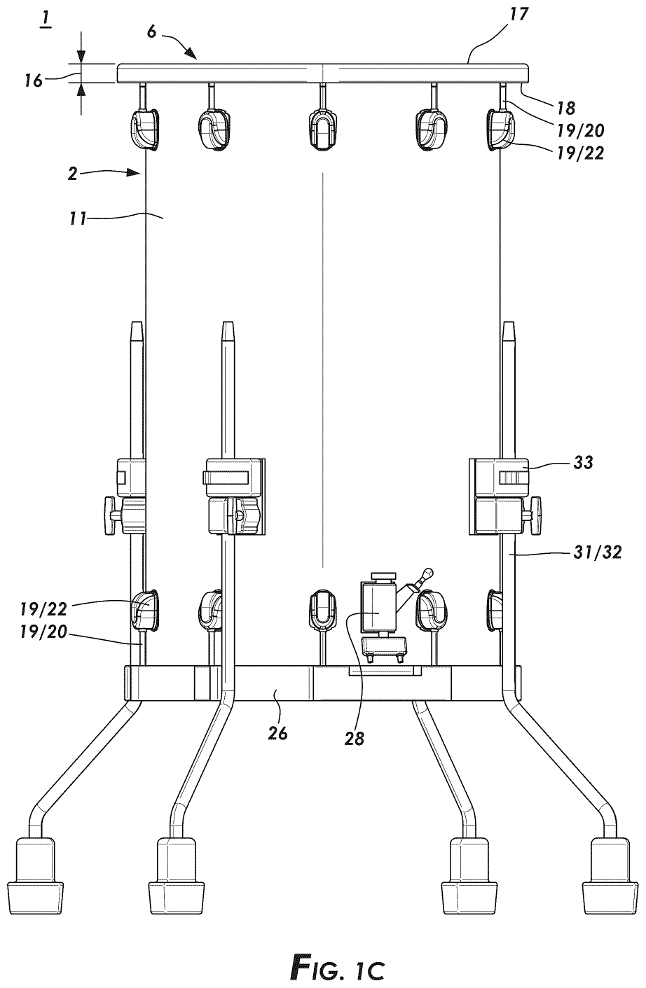

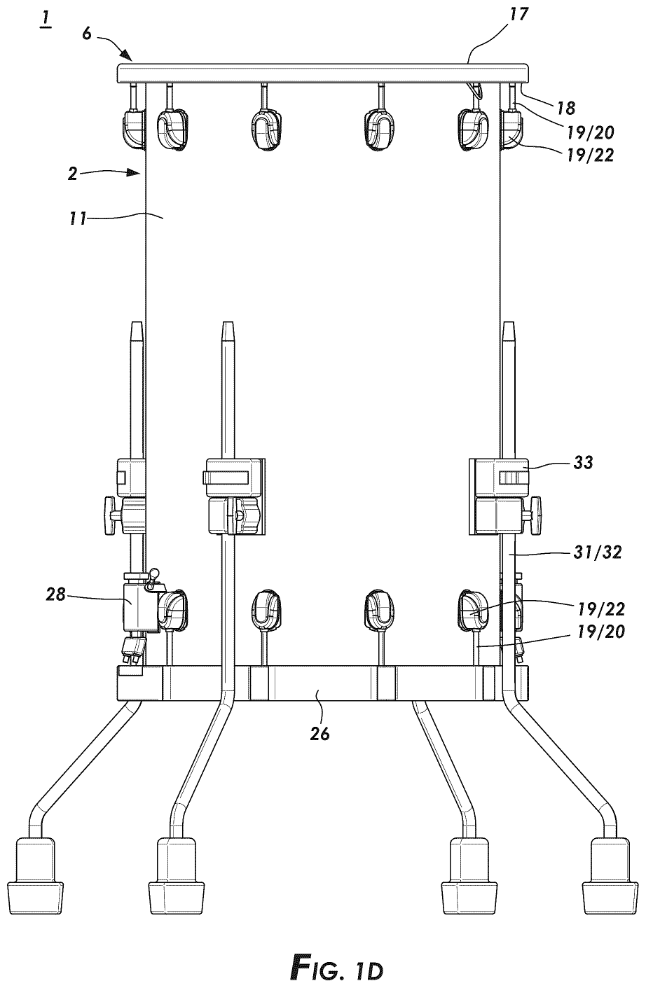

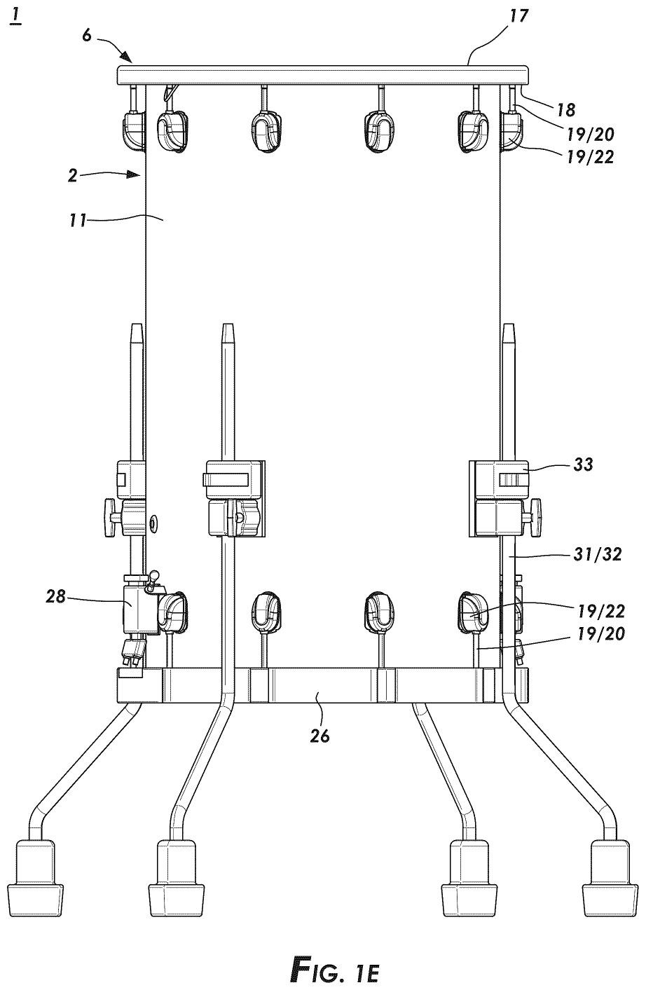

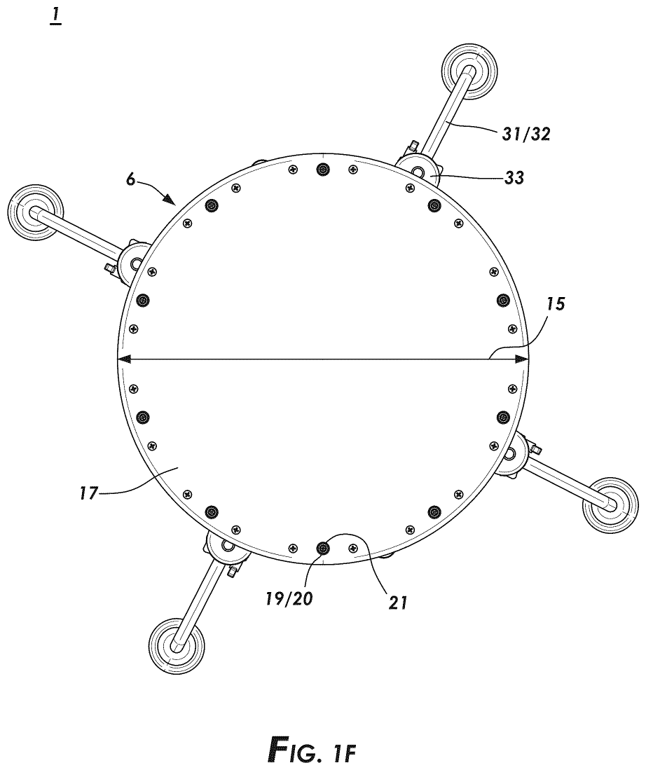

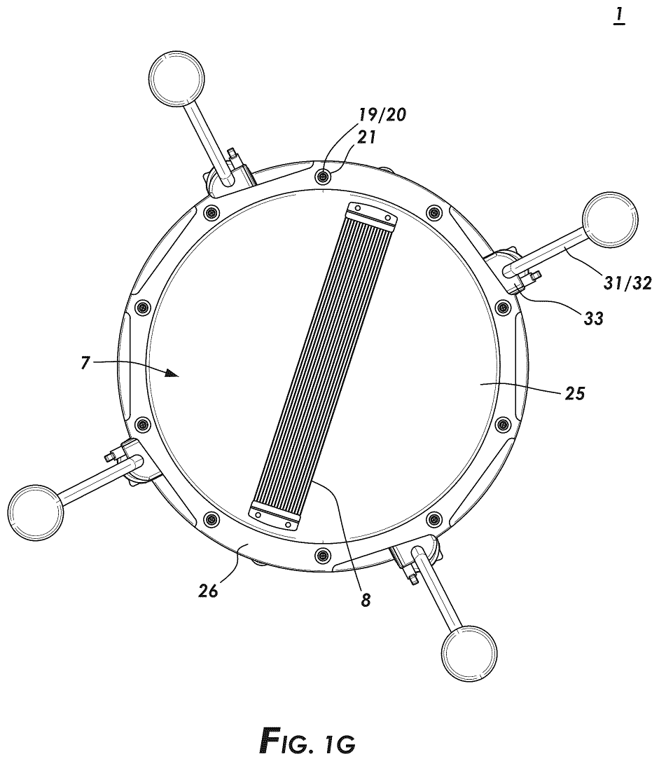

Now referring primarily to FIGS. 1A through 2, a particular embodiment of the inventive musical instrument, specifically a percussion instrument and more specifically an acoustic drum (1) which may be used as a hand drum (1), is shown. The present drum (1) includes (i) a shell (2) having a shell depth (3) extending between a shell upper end (4) and an opposing shell lower end (5), whereby the shell depth (3) can be not less than about 14 inches; (ii) a top head (6) coupled to the shell upper end (4), whereby the top head (6) comprises wood; (iii) a bottom head (7) coupled to the shell lower end (5); and (iv) at least one snare wire (8) operably coupled to the bottom head (7).

To more clearly understand and appreciate the advantages of the inventive musical instrument, a basic overview of the operation of a conventional snare drum is provided. When the top head of the snare drum is struck by a player, it is displaced and vibrates. The displacement and vibration of the top head propagate through the column of air within the shell and are conveyed as air and sound pressure to the bottom head at the opposite end of the shell. The bottom head is displaced by the air and sound pressure and correspondingly vibrates. The snare wires, lying flat against the bottom head, are driven away therefrom, such as downwardly. In returning to their original position (such as via the recovering force of snare coils), the snare wires collide with the bottom head to produce the timbre, such as a buzz, rattle, crack, snap, or the like, characteristic of a snare drum. After the collision, the displacement of the snare wires and consequent sound is repeated. The snare wires can be tightened or loosened, such as via a strainer, to change the snare wires' “crispness.” Further, the snare wires can be engaged (turned on) or disengaged (turned off), such as via the strainer.

Again referring primarily to FIGS. 1A through 2, the present drum (1) can include a shell (2), which may be substantially hollow, functioning to efficiently (i) convey internal air downwardly when the top head (6) vibrates and (ii) reverberate the vibrations inside of the shell (2). Structurally, the shell (2) can extend between an open shell upper end (4) and an opposing open shell lower end (5), whereby the distance therebetween may be considered the shell depth (3). A conventional snare drum typically has a shell depth of between about 5 inches and about 6.5 inches (such as an orchestra snare drum and a drum set snare drum), which can produce a brighter, sharper sound with more attack relative to a deeper snare drum, having a depth greater than about 6.5 inches and up to about 12 inches (such as a marching snare drum), which can produce a fuller, richer sound with more low-end tones. Significantly, the shell (2) of the present drum (1) can have a shell depth (3) of not less than about 14 inches, which by and of itself differentiates the present drum (1) from known snare drums.

Now referring primarily to FIG. 1H, the present shell (2) can have a shell depth (3) of between about 14 inches and about 36 inches. As to particular embodiments, the shell (2) can have a shell depth (3) of not less than about 14 inches. As to other particular embodiments, the shell (2) can have a shell depth (3) of not less than about 16 inches. As to other particular embodiments, the shell (2) can have a shell depth (3) of not less than about 18 inches. As to other particular embodiments, the shell (2) can have a shell depth (3) of not less than about 20 inches. As to other particular embodiments, the shell (2) can have a shell depth (3) of not less than about 22 inches. As to other particular embodiments, the shell (2) can have a shell depth (3) of not less than about 24 inches. As to other particular embodiments, the shell (2) can have a shell depth (3) of not less than about 26 inches. As to other particular embodiments, the shell (2) can have a shell depth (3) of not less than about 28 inches. As to other particular embodiments, the shell (2) can have a shell depth (3) of not less than about 30 inches. As to other particular embodiments, the shell (2) can have a shell depth (3) of not less than about 32 inches. As to other particular embodiments, the shell (2) can have a shell depth (3) of not less than about 34 inches. As to other particular embodiments, the shell (2) can have a shell depth (3) of not less than about 36 inches. Such “deep” shell depths (3) can provide a “bottom end” sound with lower bass frequencies which may simply not be attainable with a conventional snare drum.

As to particular embodiments, the shell (2) can have a fixed shell depth (3) which cannot be changed (as shown in the examples of the figures). As to other particular embodiments, the shell (2) can have an adjustable shell depth (3), such as by being comprised of two or more shell components which may dispose in vertical relation to one another, such as stackable shell components, telescoping shell components, or the like.

Again referring primarily to FIG. 1H, the present shell (2) can have an outer shell diameter (9) of between about 10 inches and about 24 inches. As to particular embodiments, the shell (2) can have a shell diameter (9) of not less than about 10 inches. As to other particular embodiments, the shell (2) can have a shell diameter (9) of not less than about 12 inches. As to other particular embodiments, the shell (2) can have a shell diameter (9) of not less than about 14 inches. As to other particular embodiments, the shell (2) can have a shell diameter (9) of not less than about 16 inches. As to other particular embodiments, the shell (2) can have a shell diameter (9) of not less than about 18 inches. As to other particular embodiments, the shell (2) can have a shell diameter (9) of not less than about 20 inches. As to other particular embodiments, the shell (2) can have a shell diameter (9) of not less than about 22 inches. As to other particular embodiments, the shell (2) can have a shell diameter (9) of not less than about 24 inches.

Again referring primarily to FIG. 1H, as to particular embodiments, the shell (2) can be cylindrical or substantially cylindrical, thus having a constant or substantially constant shell diameter (9) between the shell upper end (4) and the shell lower end (5).

As to other particular embodiments, the shell (2) can have a shell diameter (9) which varies between the shell upper end (4) and the shell lower end (5) (not shown). As to particular embodiments, the shape of the shell (2) can be asymmetric about a horizontal midline; as illustrative examples, known drums having an asymmetrical shell shape may include the conga drum, the djembe drum, and the tabla drum.

Now regarding material, the shell (2) can comprise (or be made from) a numerous and wide variety of materials, depending upon the embodiment and the desired resultant sound. As illustrative, non-limiting examples, the shell (2) can comprise (or be made from) wood (such as maple, birch, mahogany, walnut, cherry, oak, bubinga, poplar, or the like), which may be constructed as a plied shell, a steam-bent shell, a segment shell (generally constructed of multiple stacks of segmented wood rings, whereby the segments may be glued together and rounded on a lathe), a stave shell (generally constructed of vertically glued pieces of wood formed into a cylinder, similar to a barrel, and rounded on a lathe), a solid shell (generally constructed of a single solid piece of hollowed wood), or the like. As to particular embodiments, reinforcement hoops may be needed (such as on the inside surface of the shell (2)) to keep the shell (2) perfectly round.

Alternatively, the shell (2) can comprise (or be made from) metal (such as steel, aluminum, copper, bronze, brass, titanium, nickel, or the like), plastic, acrylic, fiberglass, carbon fiber, graphite, wood/resin fiber material, or any other material deemed appropriate.

The shell (2) can have any of a numerous and wide variety of shell thicknesses extending between a shell inner surface (10) and a shell outer surface (11), whereby the shell thickness may be at least partly dependent upon the material. As but a first example, the shell (2) can be a “thin” shell, having a shell thickness of about 5 millimeters or less, which may provide warm, resonant sound with good low-end response. As but a second example, the shell (2) can be a “medium” shell, having a shell thickness of between about 6 millimeters and about 8 millimeters, which may provide a balance of warmth, attack, and projection. As but a third example, the shell (2) can be a “thick” shell, having a shell thickness of about 8 millimeters or more, which may provide brighter, louder sound with more attack.

Now referring primarily to FIG. 1B, the shell (2) can include one or more vent holes (12) (or air vents) disposed therethrough to communicate between a shell interior space (13) defined by the shell inner surface (10) and the exterior space (14) therearound, whereby the vent hole (12) may function to balance air pressure by allowing air to move freely between the inside and outside of the shell (2), thereby equalizing the air pressure when the top head (6) is struck to contribute to a better overall sound and tuning range.

As to particular embodiments, the shell (2) can include a grommet (or ring of material such as metal, wood, plastic, or the like) disposed about the vent hole (12), whereby the grommet may be coupled to the shell (2) via adhesive, a mechanical fastener(s), or the like.

Now referring primarily to FIGS. 1A through 2, the present drum (1) can further include a top head (6) (or batter head) coupled to the open shell upper end (4), whereby the top head (6) functions as the surface which a player strikes (or otherwise impacts), such as directly with a hand(s) or via another apparatus such as a drumstick(s), brush(es), mallet(s), or the like. As to particular embodiments, this striking surface may be referred to as a tapa.

Significantly, the top head (6) of the present drum (1) can comprise or consist essentially of or consist of or be made from a rigid material as opposed to a “stretchable material” (such as skin or a synthetic material, like (but not limited to) a polyester film or polyethylene terephthalate or MYLAR®) that may be tuned by varying its tension or tautness over the shell upper end (4)), which by and of itself differentiates the present drum (1) from known snare drums. As to particular embodiments, the top head (6) can comprise wood. As to particular embodiments, the top head (6) can consist essentially of wood. As to particular embodiments, the top head (6) can consist of wood. As to particular embodiments, the top head (6) can comprise, consist essentially of, or consist of birch wood.

Now referring primarily to FIG. 1H, the top head (6) can be cylindrical or substantially cylindrical, thus having a circular or substantially circular cross-section. Accordingly, the top head (6) can have a top head diameter (15), which may be at least partly dependent upon the shell diameter (9).

The present top head (6) can have a top head diameter (15) of between about 10 inches and about 24 inches. As to particular embodiments, the top head (6) can have a top head diameter (15) of not less than about 10 inches. As to other particular embodiments, the top head (6) can have a top head diameter (15) of not less than about 12 inches. As to other particular embodiments, the top head (6) can have a top head diameter (15) of not less than about 14 inches. As to other particular embodiments, the top head (6) can have a top head diameter (15) of not less than about 16 inches. As to other particular embodiments, the top head (6) can have a top head diameter (15) of not less than about 18 inches. As to other particular embodiments, the top head (6) can have a top head diameter (15) of not less than about 20 inches. As to other particular embodiments, the top head (6) can have a top head diameter (15) of not less than about 22 inches. As to other particular embodiments, the top head (6) can have a top head diameter (15) of not less than about 24 inches.

Now referring primarily to FIG. 1C, the top head (6) can have a top head thickness (16) extending between a top head upper surface (17) and a top head lower surface (18), whereby the top head thickness (16) may be considered relatively “thick,” which by and of itself differentiates the present drum (1) from known snare drums that typically have a batter head thickness of between about 7 mils to about 14 mils. The present top head (6) can have a top head thickness (16) of between about 0.5 millimeters and about 10 millimeters. As to particular embodiments, the top head (6) can have a top head thickness (16) of not less than about 0.5 millimeters. As to other particular embodiments, the top head (6) can have a top head thickness (16) of not less than about 1 millimeter. As to other particular embodiments, the top head (6) can have a top head thickness (16) of not less than about 2 millimeters. As to other particular embodiments, the top head (6) can have a top head thickness (16) of not less than about 3 millimeters. As to other particular embodiments, the top head (6) can have a top head thickness (16) of not less than about 4 millimeters. As to other particular embodiments, the top head (6) can have a top head thickness (16) of not less than about 5 millimeters. As to other particular embodiments, the top head (6) can have a top head thickness (16) of not less than about 6 millimeters. As to other particular embodiments, the top head (6) can have a top head thickness (16) of not less than about 7 millimeters. As to other particular embodiments, the top head (6) can have a top head thickness (16) of not less than about 8 millimeters. As to other particular embodiments, the top head (6) can have a top head thickness (16) of not less than about 9 millimeters. As to other particular embodiments, the top head (6) can have a top head thickness (16) of not less than about 10 millimeters. Such “thick” top heads (6) can provide a warmer and/or thicker sound.

As to particular embodiments, the top head upper surface (17) can be smooth. As to other particular embodiments, the top head upper surface (17) can be textured, which may provide different sound(s) relative to a smooth top head upper surface (17), for example when “brushed” with a brush.

The top head (6) can be coupled or connected or attached or mounted to the shell upper end (4) to effectively close its opening. Accordingly, the top head diameter (15) can be greater than the diameter of the shell upper end (4). Following placement, the top head (6) can be fastened (or secured) to the shell upper end (4), such as via one of more fasteners (19).

Said fasteners (19) can have any of a numerous and wide variety of configurations sufficient to fasten the top head (6) to the shell upper end (4). As but a first illustrative example, the fasteners (19) can be configured as rods (20) (or bolts or screws), such as with threads, which may be received within corresponding holes (21) (or apertures) disposed through the top head (6). As but a second illustrative example (which may work in conjunction with the first illustrative example), the fasteners (19) can include lugs (22) which may be fixed to the shell outer surface (11), whereby a lug (22) can include a threaded hole internally provided and extending downwardly from the upper portion thereof. The rod (20), passing through the top head (6) via its hole (21), can be received within the threaded hole of the lug (22) to fasten the top head (6) to the shell upper end (4). Such a threaded system may allow for relatively easy (i) attachment of the top head (6) to the shell (2) and (ii) detachment of the top head (6) from the shell (2).

For fastening, the holes (21) disposed through the top head (6) can be provided in any number at regular intervals around the peripheral portion of the top head (6), whereby the number and spacing may be at least partly dependent upon the top head diameter (15). As but one illustrative example, a top head (6) having a top head diameter (15) of about 14 inches can have eight holes (21) disposed therethrough and may be fastened to the shell upper end (4) by eight rods (20), each received by a threaded hole of a corresponding lug (22). As but another illustrative example, a top head (6) having a top head diameter (15) of about 14 inches can have ten holes (21) disposed therethrough and may be fastened to the shell upper end (4) by ten rods (20), each received by a threaded hole of a corresponding lug (22).

Notably, in contrast to the batter head of a conventional snare drum, the present top head (6) may be fastened to the shell upper end (4) without the use of a hoop. Further, in contrast to the batter head of a conventional snare drum, the present top head (6) may not be tensionable and/or tunable.

As to other particular embodiments, instead of the top head (6) comprising a rigid material such as wood, the top head (6) can be configured as conventional drum head which may be (i) tensionable and/or tunable and (ii) fastened to the shell upper end (4) with a hoop (not shown).

Now referring primarily to FIGS. 1G and 2, the present drum (1) can further include a bottom head (7) (or snare side head) coupled to the open shell lower end (5), whereby the bottom head (7) functions as a resonant head which vibrates when the top head (6) is struck.

The bottom head (7) of the present drum (1) can comprise (or be made from) a “stretchable material” (such as skin or a synthetic material, like (but not limited to) a polyester film or polyethylene terephthalate or MYLAR®) which can be tuned by varying its tension or tautness over the shell lower end (5). As to particular embodiments, the bottom head (7) can be similar to or the same as a snare side head of a conventional snare drum.

Now referring primarily to FIG. 1H, the bottom head (7) can be cylindrical or substantially cylindrical, thus having a circular or substantially circular cross-section. Correspondingly, the bottom head (7) can have a bottom head diameter (23), which may be at least partly dependent upon the shell diameter (9).

The present bottom head (7) can have a bottom head diameter (23) of between about 10 inches and about 24 inches. As to particular embodiments, the bottom head (7) can have a bottom head diameter (23) of not less than about 10 inches. As to other particular embodiments, the bottom head (7) can have a bottom head diameter (23) of not less than about 12 inches. As to other particular embodiments, the bottom head (7) can have a bottom head diameter (23) of not less than about 14 inches. As to other particular embodiments, the bottom head (7) can have a bottom head diameter (23) of not less than about 16 inches. As to other particular embodiments, the bottom head (7) can have a bottom head diameter (23) of not less than about 18 inches. As to other particular embodiments, the bottom head (7) can have a bottom head diameter (23) of not less than about 20 inches. As to other particular embodiments, the bottom head (7) can have a bottom head diameter (23) of not less than about 22 inches. As to other particular embodiments, the bottom head (7) can have a bottom head diameter (23) of not less than about 24 inches.

The bottom head (7) can have a bottom head thickness extending between a bottom head upper surface (24) and a bottom head lower surface (25). The bottom head (7) can have a relatively thin bottom head thickness, for example but not limited to between about 2 mils and about 5 mils. As to particular embodiments, the bottom head (7) can have a bottom head thickness of not greater than about 5 mils. As to other particular embodiments, the bottom head (7) can have a bottom head thickness of not greater than about 4.5 mils. As to other particular embodiments, the bottom head (7) can have a bottom head thickness of not greater than about 4 mils. As to other particular embodiments, the bottom head (7) can have a bottom head thickness of not greater than about 3.5 mils. As to other particular embodiments, the bottom head (7) can have a bottom head thickness of not greater than about 3 mils. As to other particular embodiments, the bottom head (7) can have a bottom head thickness of not greater than about 2.5 mils. As to other particular embodiments, the bottom head (7) can have a bottom head thickness of not greater than about 2 mils.

The bottom head (7) can be coupled or connected or attached or mounted to the shell lower end (5) to effectively close its opening. Accordingly, the bottom head diameter (23) can be (slightly) greater than the diameter of the shell lower end (5). As to particular embodiments, the bottom head (7) can be coupled to the shell lower end (5) via a hoop (26) configured as an annular member, whereby the hoop (26) may have a hoop inner diameter (27) slightly greater than the outer diameter of the shell lower end (5). As the bottom head (7) can have a bottom head diameter (23) slightly lesser than the hoop inner diameter (27), the bottom head (7) may dispose within the hoop (26) (such as via a flange) for subsequent coupling to the shell lower end (5).

The hoop (26) can comprise (or be made from) a numerous and wide variety of materials, depending upon the embodiment. As illustrative, non-limiting examples, the hoop (26) can be made from wood, metal, plastic, acrylic, fiberglass, carbon fiber, graphite, or any other material deemed appropriate.

Following disposition of the bottom head (7) within the hoop (26), the hoop (26) can be fastened (or secured) to the shell lower end (5), such as via one of more fasteners (19). As to particular embodiments, the fasteners (19) can be similar to or the same as the fasteners used to fasten a snare side head to a conventional snare drum.

As but a first illustrative example, the fasteners (19) can be configured as rods (20) (or bolts or screws), such as with threads, which may be received within corresponding holes (21) (or apertures) disposed through the hoop (26). As but a second illustrative example (which may work in conjunction with the first illustrative example), the fasteners (19) can include lugs (22) which may be fixed to the shell outer surface (11), whereby a lug (22) can include a threaded hole internally provided and extending upwardly from the lower portion thereof. The rod (20), passing through the hoop (26) in which the bottom head (7) disposes via its hole (21), can be received within the threaded hole of the lug (22) to fasten the bottom head (7) to the shell lower end (5). As to particular embodiments, the tensionable bottom head (7) can be tuned via the tightening and loosening of the rods (20).

For fastening, the holes (21) disposed through the hoop (26) can be provided in any number at regular intervals around the hoop (26), whereby the number and spacing may be at least partly dependent upon the diameter of the hoop (26) and/or the bottom head diameter (23). As but one illustrative example, a hoop (26) which supports a bottom head (7) having a bottom head diameter (23) of about 14 inches can have eight holes (21) disposed therethrough and may be fastened to the shell lower end (5) by eight rods (20), each received by a threaded hole of a corresponding lug (22). As but another illustrative example, a hoop (26) which supports a bottom head (7) having a bottom head diameter (23) of about 14 inches can have ten holes (21) disposed therethrough and may be fastened to the shell lower end (5) by ten rods (20), each received by a threaded hole of a corresponding lug (22).

Now referring primarily to FIGS. 1G and 2, the present drum (1) can further include one or more snare wires (8) operably coupled to the bottom head (7), whereby the snare wires (8) may be driven away from the bottom head (7), such as downwardly, via vibrations originating from the top head (6). In returning to their original position, the snare wires (8) can vibrate against the bottom head (7) to produce a buzzing sound, rattling sound, cracking sound, snapping sound, or the like.

Structurally, snare “wires” (8) can be made from metal (such as, but not limited to, steel, stainless steel, carbon steel, chrome-plated steel, brass, phosphor bronze, or the like, which may be coated or not, depending upon the embodiment and the desired resultant sound), a flexible polymer, nylon, animal intestine/gut, or the like. Further, snare “wires” (8) can be configured as (i) strings, coils, or the like, or (ii) flexible interconnected members, mesh, webbing, or the like.

The snare wires (8) can be disposed within the perimeter of the bottom head (7) and span or extend diametrically thereacross. Additionally, the snare wires (8) can contact (or substantially contact) or engage with (or substantially engage with) the bottom head (7), thus producing a snare sound when the drum (1) is played. Further, the snare wires (8) can be tightened or loosened, such as with a strainer (28) (or similar apparatus), to change the “crispness” of the snare wires (8).

Alternatively, the snare wires (8) can be adjusted, such as via the strainer (28), to be spaced apart (or disengaged) from the bottom head (7) and thus not contact the bottom head (7) to “turn off” the snare wires (8). Correspondingly, a snare sound may not be produced when the drum (1) is played; as a result, the predominant sound of the played drum (1) can be associated with the top head (6).

Again referring primarily to FIGS. 1G and 2, as to particular embodiments, the snare wires (8) can be disposed proximate and contact the bottom head lower surface (25). As to other particular embodiments, the snare wires (8) can be disposed proximate and contact the bottom head upper surface (24) (not shown).

As to particular embodiments, the present snare wires (8) can be similar to or the same as snare wires of a conventional snare drum. Additionally, as to particular embodiments, the snare wires (8) can be secured to the shell (2) via a snare butt which may be similar to or the same as a snare butt of a conventional snare drum.

As to particular embodiments, the strainer (28), which can be disposed proximate the shell outer surface (11), may be similar to or the same as a strainer of a conventional snare drum.

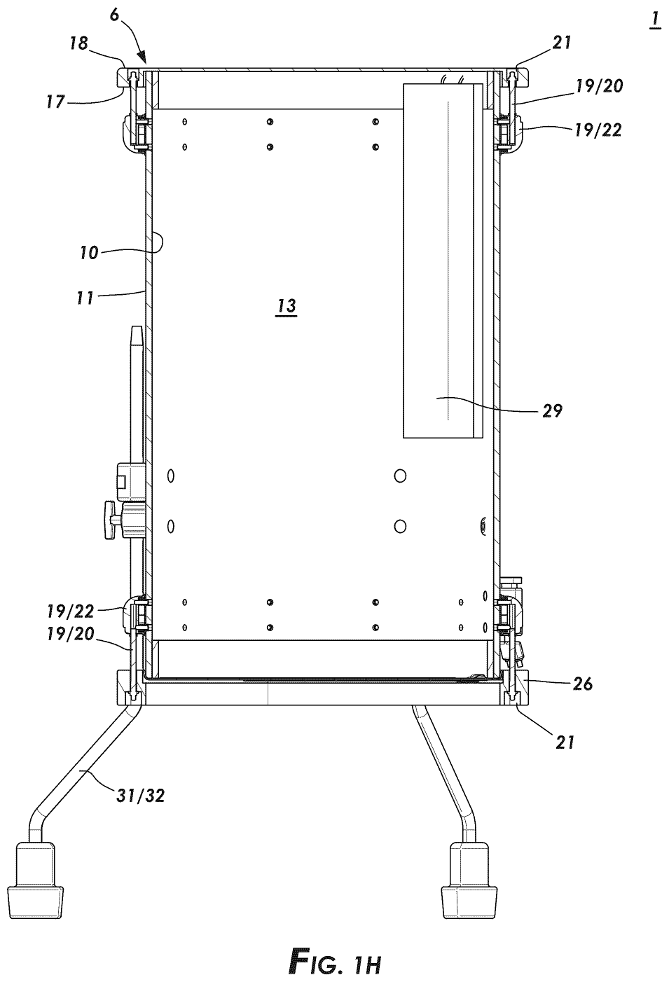

Now referring primarily to FIG. 3, the present drum (1) can further include one or more sound modifiers (29) disposed within the shell (2), whereby a sound modifier (29) may function to modify the sound of the drum (1) or tune the drum (1), such as by absorbing a portion of the vibrations resonating within the shell (1). As illustrative, non-limiting examples, the sound modifier (29) can be effective to baffle, muffle, dampen, quiet, soften, deaden, mute, or change the sound of the drum (1) or certain frequencies thereof. As but one illustrative, nonlimiting example, the sound modifier (29) can comprise an absorbent panel, which may be made from a numerous and wide variety of absorbent materials, such as textiles, fabric, cloth, or the like.

The sound modifier (29) can have any of a numerous and wide variety of dimensions, depending upon the embodiment and the desired resultant sound. As but one illustrative example, the sound modifier (29) can comprise a panel of absorbent material having a width of about six inches and a length of about seven inches. As but a second illustrative example, the sound modifier (29) can comprise a panel of absorbent material having a width of about six inches and a length of about fourteen inches.

Further, a various number of sound modifiers (29) can be employed, depending upon the embodiment and the desired resultant sound. As but one illustrative example, only one sound modifier (29) can be employed. As but a second illustrative example, two or more sound modifiers (29), whether the same or different, can be employed.

Moreover, the sound modifiers (29) can be disposed in any of a numerous and wide variety of locations within the shell (2), again depending upon the embodiment and the desired resultant sound. As to particular embodiments, the sound modifiers (29) can be configured for hanging within the shell (2). As to particular embodiments, the sound modifiers (29) can be configured for stacking a plurality thereof within the shell (2).

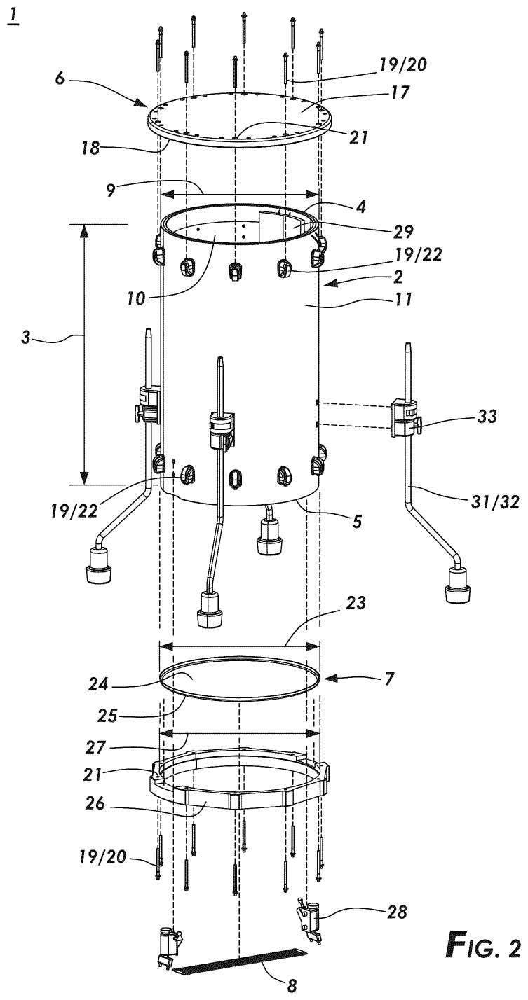

Now referring primarily to FIGS. 4A and 4B, the shell (2) can further include one or more sound ports (30) disposed therethrough to communicate between the shell interior space (13) defined by the shell inner surface (10) and the exterior space (14) therearound, whereby the sound port (30) may provide for the escape of sound waves from the resonant chamber defined by the top head (6), the shell (2), and the bottom head (7). The sound port (30) can have any of a numerous and wide variety of shapes and be provided in varied numbers, depending upon the embodiment and the desired resultant sound. Further, the sound port (30) can be disposed in any of a numerous and wide variety of locations about the shell (2), again depending upon the embodiment and the desired resultant sound. As to particular embodiments, the sound port (30) can be pluggable to provide (i) an open condition of the sound port (30) when unplugged and (ii) a closed condition of the sound port (30) when plugged, such as with a plug (not shown).

As to particular embodiments, the present drum (1) can further include one or more microphones disposed within the shell interior space (13) (not shown), such as the MAY Internal Miking System which is available from Randall May International in Irvine, California, USA.

Now referring primarily to FIGS. 1A through 2, the present drum (1) can further include one or more supports (31) coupled thereto, whereby a support can facilitate supporting the drum (1) on a support surface. As to particular embodiments, the support (31) can be configured as a leg (32) which downwardly (and/or radially outwardly) extends, such as from the shell (2). Significantly, a plurality of legs (32) can effectively stabilize the drum (1) while playing at any velocity and at any volume. For this purpose, as to particular embodiments, the present drum (1) can include four legs (32) disposed in spaced-apart relation about the shell (2), whereby each leg (32) may be coupled to the drum (1), such as the shell (2), via a coupler (33), such as a bracket. Notably, such a support configuration can be in contrast to the tripod stand of a conventional snare drum, which may simply not be sturdy enough to withstand the rigors of hand playing and can correspondingly “creep” or “walk” under such playing conditions.

As to particular embodiments, the legs (32) can be height-adjustable, which may be advantageous in allowing a player to play the present drum (1) in either a seated or standing position.

As to particular embodiments, the present drum (1) can further include one or more couplers coupled thereto, whereby a coupler can facilitate coupling of the drum (1) to a player (not shown). As to particular embodiments, the coupler can be configured as a strap, a drum carrier, or the like.

As to particular embodiments, the present drum (1) can further include one or more handles coupled thereto (for example coupled to the shell (2)), whereby a handle can facilitate handling of the drum (1) (not shown), such as for transport of the drum (1).

As to particular embodiments, the present drum (1) can further include one or more mounts coupled thereto, whereby a mount can facilitate mounting of an accessory on the drum (1) (not shown). As but one illustrative example, a mount can be configured as a coupler, such as a bracket; accordingly, a rod (such as an “L” rod or a “Z” rod) may be disposed in such a coupler for supporting an accessory, such as a percussion instrument, for example a woodblock, cowbell, tambourine, castanets, or the like.

A method of making the present drum (1) detailed above can include providing a shell (2) having a shell depth (3) extending between a shell upper end (4) and an opposing shell lower end (5), whereby the shell depth (3) can be not less than about 14 inches; coupling a top head (6) to the shell upper end (4), whereby the top head (6) comprises wood; coupling a bottom head (7) to the shell lower end (5); and operably coupling one or more snare wires (8) to the bottom head (7).

The method of making the present drum (1) can further include providing additional components of the drum (1), as described above and in the claims.

A method of using the present drum (1) detailed above can include playing the drum (1) by striking the top head (6) to produce vibrations within the resonant chamber.

In use, the present drum (1) can have a distinctive frequency response or range of frequencies it produces when struck, whereby said frequencies give the drum (1) its tonal qualities and characteristics. Specifically, the frequency response of the present drum (1) is different than that of a conventional snare drum, as detailed in the below Examples which compare (i) an embodiment of the present drum (1) having a wooden (maple) shell with a shell depth (3) of about 24 inches and a shell diameter (9) of about 14 inches, a birch top head (6), a Remo Powerstroke 4 bottom head (4) (available from Remo, Inc. in Valencia, California, USA), and snares with medium-low tension, and (ii) a conventional TAMA® snare drum having a wooden (maple) shell with a shell depth (3) of about 5.5 inches and a shell diameter (9) of about 14 inches, a birch top head, a Remo snare side bottom head (available from Remo, Inc. in Valencia, California, USA), and snares with medium-high tension. Each test recording was done in a studio recording environment, had a duration of 30 seconds, and included 20 measures (4/4) at 150 beats per minute; frequency data is provided in Hz and intensity or loudness of sound data is provided in dB. The drummer performed all hand strikes on the upper surface of the drums' top heads with a consistent pressure and style. The Digital Audio Workstation (DAW) software used for the comparative analysis was Pro Tools Studio 2024.6.0 (available from Avid Technology, Inc. in Burlington, Massachusetts, USA), and the frequency analyzer used for the comparative analysis was FabFilter Pro-Q 3 (available from FabFilter B.V. in The Netherlands).

In the below Examples, the term low frequency includes a sub-bass frequency range of about 20 Hz to about 60 Hz, and bass frequency range of about 60 Hz to about 250 Hz; the term mid frequency includes a low midrange frequency range of about 250 Hz to about 500 Hz, a midrange frequency range of about 500 Hz to about 2 kilohertz (kHz), and a high midrange frequency range of about 2 kHz to about 5 kHz; and the term high frequency includes a high frequency range of about 5 kHz to about 20 kHz.

### Example 1

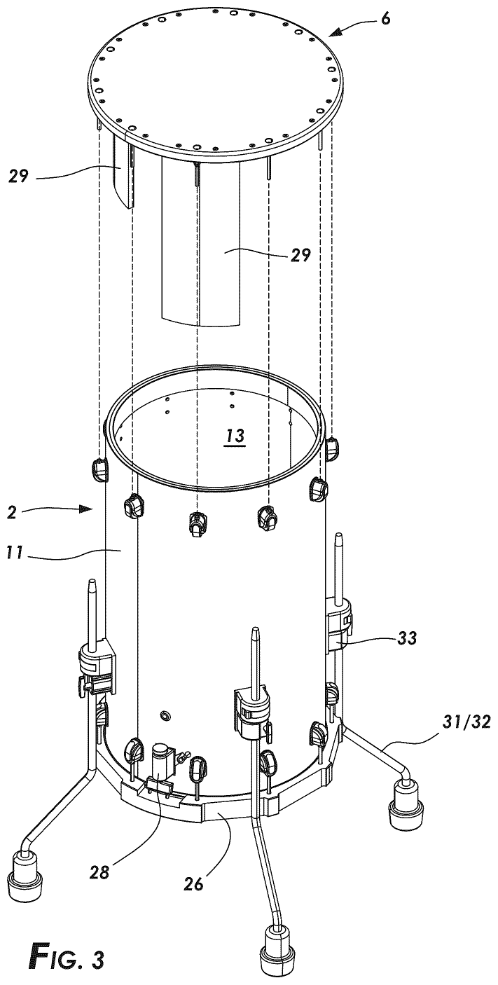

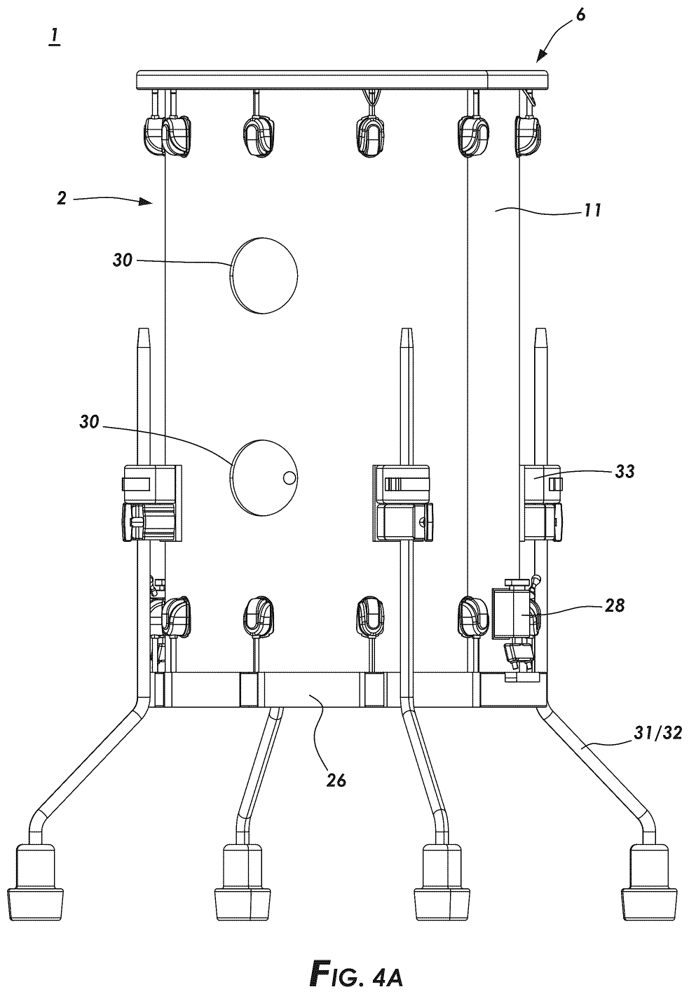

The frequency responses of the present drum (1) and the conventional snare drum were determined using a Neuman TLM103 microphone (available from Georg Neumann GmbH) which was centered about 12 inches above the drum head, whereby the frequency response curves are shown in FIGS. 5A and 5B, respectively. The maximum sample output of the present drum (1) was +1.0 decibels greater than that of the conventional snare drum. The low frequency output of the present drum (1) (+4.1 dB at 150 Hz) was greater than that of the conventional snare drum (+2.7 dB at 150 Hz). The low-midrange frequency output of the present drum (1) (+1.2 dB at 336 Hz) was greater than that of the conventional snare drum (0.0 dB at 336 Hz). At the low end, the midrange frequency output of the present drum (1) (+1.2 dB at 637 Hz) was greater than that of the conventional snare drum (−3.0 dB at 637 Hz). At the high end, the midrange frequency output of the conventional snare drum (−1.2 dB at 1.4 kHz) was greater than that of the present drum (1) (−2.1 dB at 1.4 kHz). The high frequency output of the conventional snare drum (−2.0 dB at 5.1 kHz) was greater than that of the present drum (1) (−2.7 dB at 5.1 kHz). The sub-bass frequencies of the present drum (1) and the conventional snare drum cut at an approximately equal slope. The high frequencies of the present drum (1) and the conventional snare drum cut at an approximately equal slope.

### Example 2

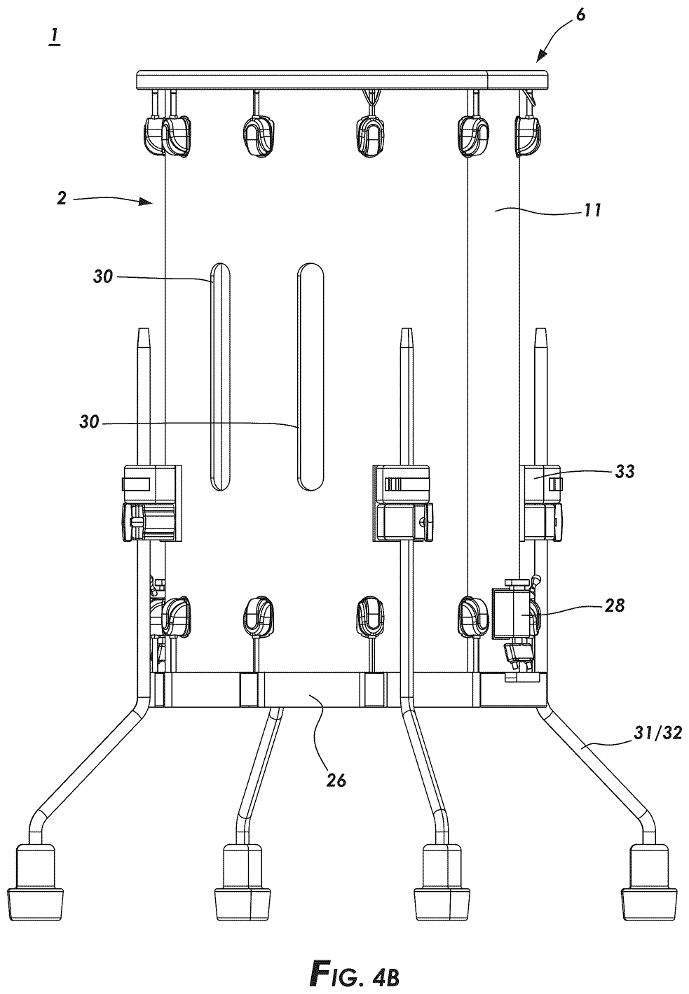

The frequency responses of the present drum (1) and the conventional snare drum were determined using a Neuman TLM103 microphone (available from Georg Neumann GmbH) which was positioned about 6 inches off of the midpoint of the drum shell, whereby the frequency response curves are shown in FIGS. 6A and 6B, respectively. The maximum sample output of the present drum (1) was +1.0 decibels greater than that of the conventional snare drum. The low frequency output of the present drum (1) (+1.5 dB at 161 Hz) was greater than that of the conventional snare drum (−1.6 dB at 161 Hz). The low-midrange frequency output of the present drum (1) (+1.6 dB at 336 Hz) was greater than that of the conventional snare drum (−0.3 dB at 336 Hz). At the low end, the midrange frequency output of the conventional snare drum (−3.0 dB at 754 Hz) was greater than that of the present drum (1) (−3.7 dB at 754 Hz). At the high end, the midrange frequency output of the conventional snare drum (−0.5 dB at 1.5 kHz) was greater than that of the present drum (1) (−4.4 dB at 1.5 kHz). The high frequency output of the conventional snare drum (−0.9 dB at 6.1 kHz) was greater than that of the present drum (1) (−4.3 dB at 6.1 kHz). The sub-bass frequencies of the present drum (1) and the conventional snare drum cut at an approximately equal slope. The high frequencies of the present drum (1) and the conventional snare drum cut at an approximately equal slope.

### Example 3

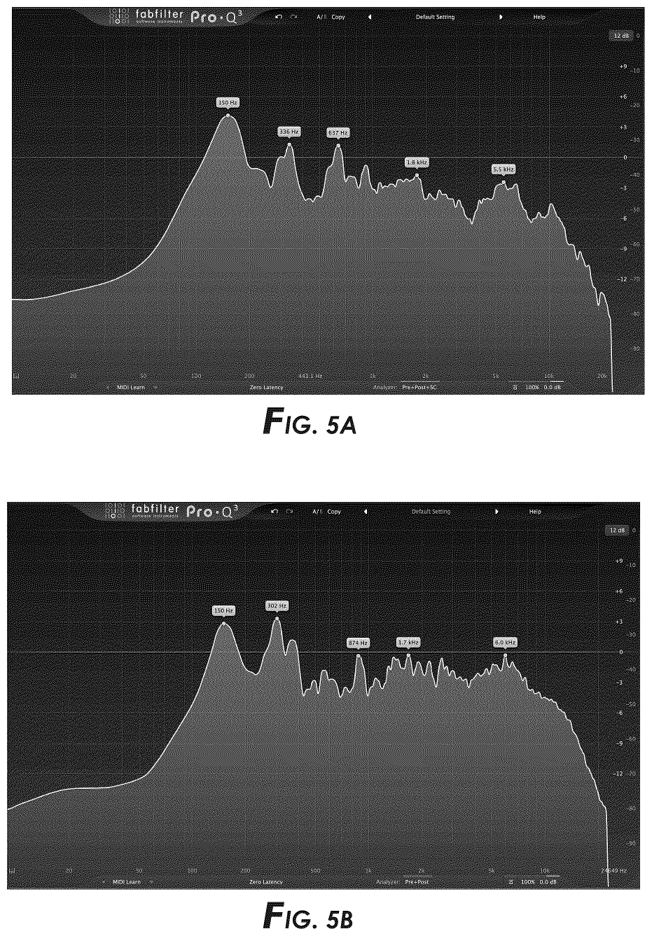

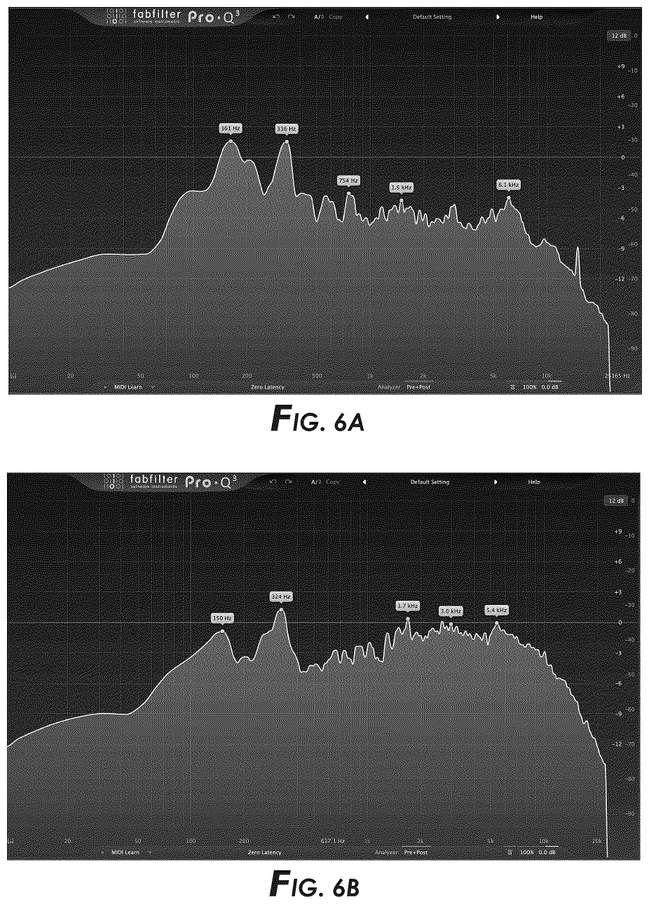

The frequency responses of the present drum (1) and the conventional snare drum were determined using a PreSonus PM-2 microphone (available from PreSonus Audio Electronics, Inc.) which was centered about 12 inches above the drum head, whereby the frequency response curves are shown in FIGS. 7A and 7B, respectively. The maximum sample output of the present drum (1) was slightly greater than that of the conventional snare drum. The low frequency output of the present drum (1) (+2.1 dB at 140 Hz) was greater than that of the conventional snare drum (−0.6 dB at 140 Hz). The low-midrange frequency output of the present drum (1) (+1.2 dB at 336 Hz) was greater than that of the conventional snare drum (−0.8 dB at 336 Hz). At the low end, the midrange frequency output of the present drum (1) (+0.5 dB at 637 Hz) was greater than that of the conventional snare drum (−2.9 dB at 637 Hz). At the high end, the midrange frequency output of the present drum (1) (−1.3 dB at 1.8 kHz) was greater than that of the conventional snare drum (−3.3 dB at 1.8 kHz). The high frequency output of the conventional snare drum (−2.8 dB at 6.5 kHz) was greater than that of the present drum (1) (−3.4 dB at 6.5 kHz). The low frequencies of the present drum (1) and the conventional snare drum cut at an approximately equal slope. The high frequencies of the present drum (1) and the conventional snare drum cut at an approximately equal slope.

### Example 4

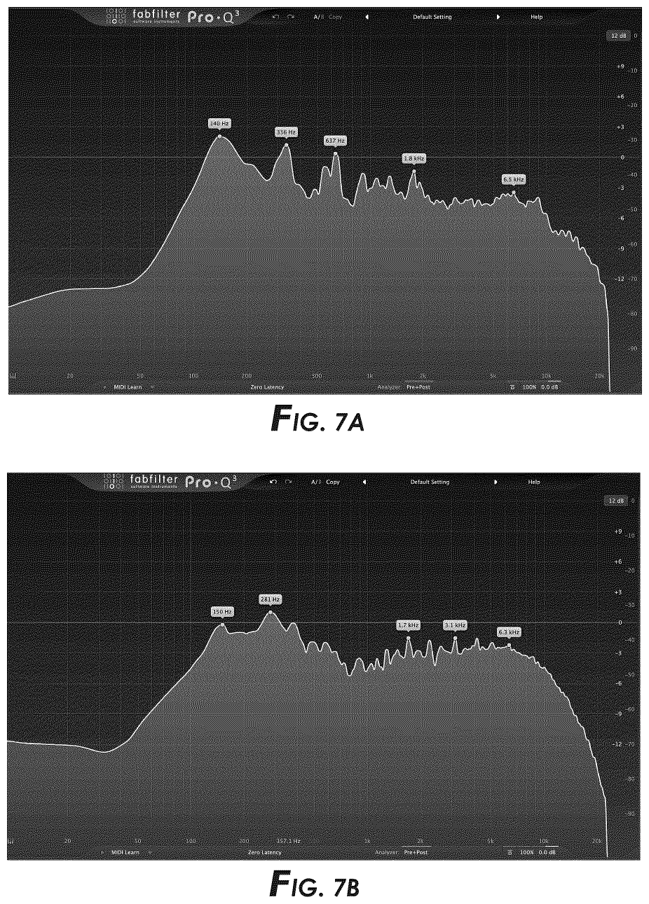

The frequency responses of the present drum (1) and the conventional snare drum were determined using a PreSonus PM-2 microphone (available from PreSonus Audio Electronics, Inc.) which was positioned about 6 inches off of the midpoint of the drum shell, whereby the frequency response curves are shown in FIGS. 8A and 8B, respectively. The maximum sample output of the conventional snare drum was +2.4 decibels greater than that of the present drum (1). The low frequency output of the present drum (1) (+0.6 dB at 140 Hz) was greater than that of the conventional snare drum (−2.7 dB at 140 Hz). The low-midrange frequency output of the conventional snare drum (+2.3 dB at 336 Hz) was greater than that of the present drum (1) (+0.3 dB at 336 Hz). At the low end, the midrange frequency output of the conventional snare drum (−1.3 dB at 615 Hz) was greater than that of the present drum (1) (−2.2 dB at 615 Hz). At the high end, the midrange frequency output of the conventional snare drum (+0.6 dB at 1.3 kHz) was greater than that of the present drum (1) (−3.3 dB at 1.3 kHz). The high frequency output of the conventional snare drum (+0.6 dB at 6.7 kHz) was greater than that of the present drum (1) (−3.6 dB at 6.7 kHz). The high frequencies of the present drum (1) and the conventional snare drum cut at an approximately equal slope.

### Example 5

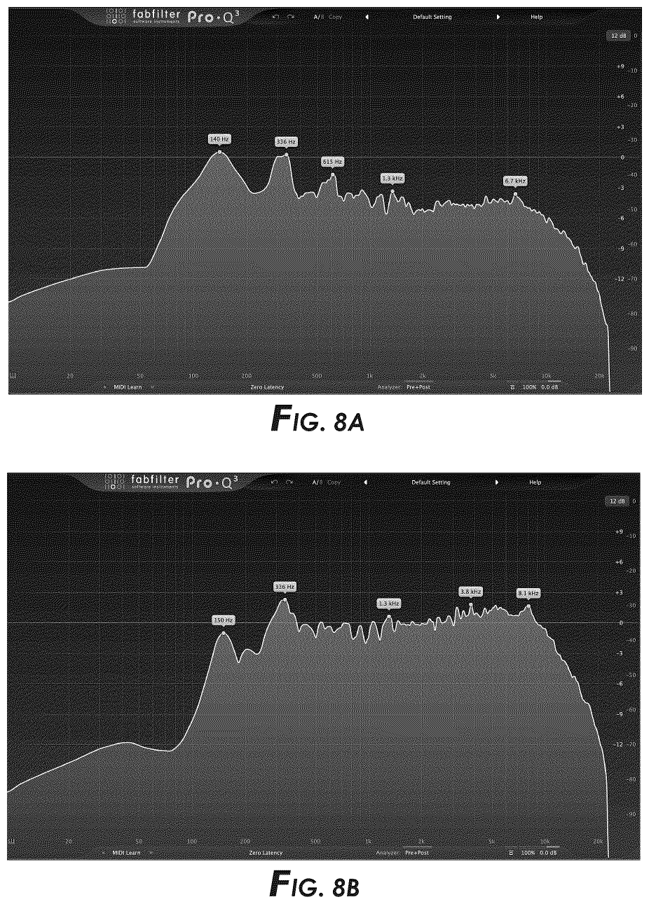

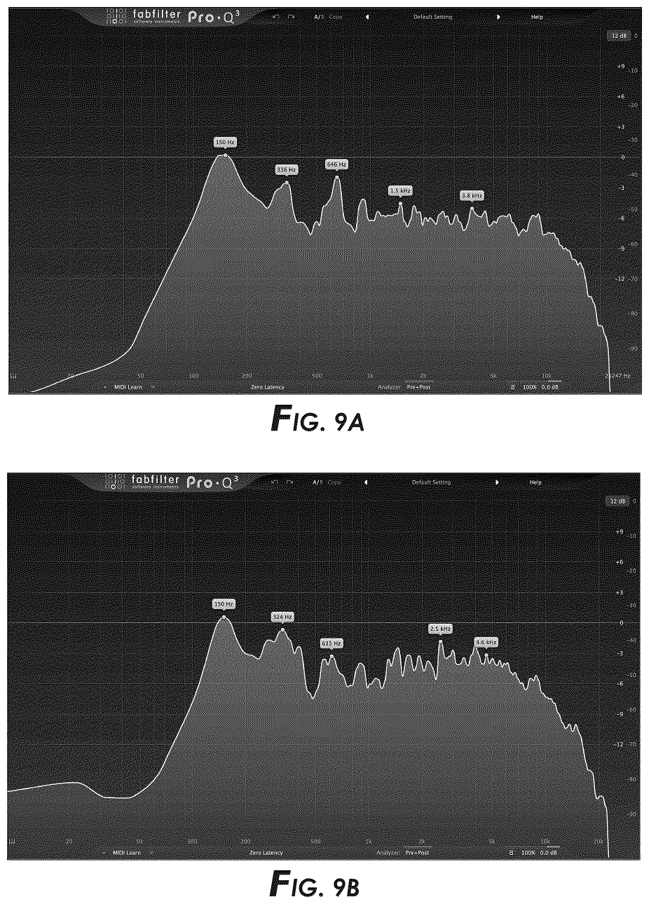

The frequency responses of the present drum (1) and the conventional snare drum were determined using a Shure SM58® microphone (available from Shure Inc.) which was centered about 12 inches above the drum head, whereby the frequency response curves are shown in FIGS. 9A and 9B, respectively. The maximum sample output of the present drum (1) was +1.0 decibel greater than that of the conventional snare drum. The low frequency output of the conventional snare drum (+0.5 dB at 150 Hz) was greater than that of the present drum (1) (0.0 dB at 150 Hz). The low-midrange frequency output of the conventional snare drum (−0.8 dB at 324 Hz) was greater than that of the present drum (1) (−2.2 dB at 336 Hz). The midrange frequency output of the present drum (1) (−1.8 dB at 646 Hz) was greater than that of the conventional snare drum (−3.4 dB at 615 Hz). The high-midrange frequency output of the conventional snare drum (−1.9 dB at 2.5 kHz and −3.2 dB at 4.6 kHz) was greater than that of the present drum (1) (−5.7 dB at 3.8 kHz).

### Example 6

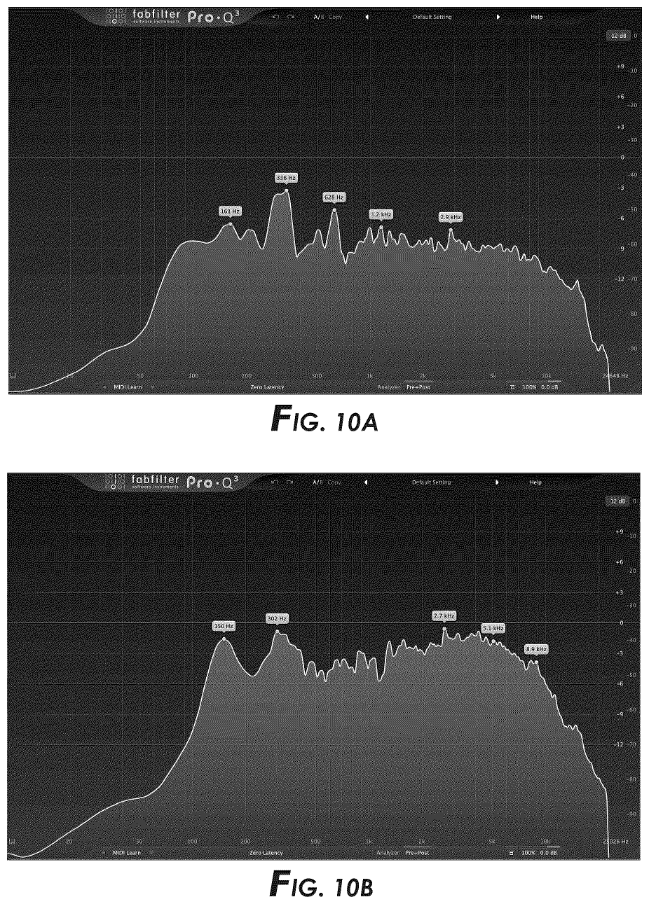

The frequency responses of the present drum (1) and the conventional snare drum were determined using a Shure SM58® microphone (available from Shure Inc.) which was positioned about 6 inches off of the midpoint of the drum shell, whereby the frequency response curves are shown in FIGS. 10A and 10B, respectively. The maximum sample output of the conventional snare drum was +6.0 decibels greater than that of the present drum (1). The low frequency output (−1.5 at 150 Hz) of the conventional snare drum was greater than that of the present drum (1) (−6.6 dB at 161 Hz). The low midrange frequency output of the conventional snare drum (−0.8 dB at 302 Hz) was greater than that of the present drum (1) (−3.3 dB at 336 Hz). The high-midrange frequency output of the conventional snare drum (−0.6 dB at 2.7 kHz and −2.0 dB at 5.1 kHz) was greater than that of the present drum (1) (−7.3 dB at 2.9 kHz). The sub-bass frequencies of the present drum (1) and the conventional snare drum cut at an approximately equal slope. The high frequencies of the present drum (1) and the conventional snare drum cut at an approximately equal slope.

For the majority of test configurations, (i) the maximum sample output of the present drum (1) was greater than that of the conventional snare drum, (ii) the low frequency output of the present drum (1) was greater than that of the conventional snare drum, and (iii) the high frequency output of the conventional snare drum was greater than that of the present drum (1). The midrange frequency output was greater for the present drum (1) in some test configurations, but greater for the conventional snare drum in other test configurations.

Subjectively, the present drum (1) produced a warm, round tone with emphasis on the low end, making it suitable for situations where rich percussion depth may be desired. Additionally, the present drum (1) produced a more subdued high end with less snare wire response. In contrast, the conventional snare drum produced a crisp attack overall, making it suitable for situations where clarity and brightness may be desired.

Overall, the present drum (1) can provide a “deep,” “smooth,” “rich,” and “resonant” sound, whereas a conventional snare drum typically provides a “snappy,” “forward,” “sharp,” and “buzzing” sound.

As can be easily understood from the foregoing, the basic concepts of the present invention may be embodied in a variety of ways. The invention involves numerous and varied embodiments of a drum and methods for making and using such a drum.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of an “coupler” and even a “means for coupling.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result. When a particular element is expressed as an approximation by use of the antecedent “substantially” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the drum embodiments herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this present disclosure.

1. An acoustic drum comprising:
a shell comprising a shell depth extending between a shell upper end and an opposing shell lower end;
wherein said shell depth is not less than about 14 inches;
a top head coupled to said shell upper end;
wherein said top head comprises wood;
a bottom head coupled to said shell lower end; and
at least one snare wire operably coupled to said bottom head.

2. The drum of claim 1, wherein said shell depth is between about 14 inches and about 36 inches.

3. The drum of claim 1, wherein said shell depth is fixed.

4. The drum of claim 1, wherein said shell depth is adjustable.

5. The drum of claim 1, wherein said shell comprises an outer shell diameter of not less than about 10 inches.

6. The drum of claim 1, wherein said shell comprises an outer shell diameter of between about 10 inches and about 24 inches.

7. The drum of claim 1, wherein said shell is substantially cylindrical and comprises a substantially constant shell diameter between said shell upper end and said shell lower end.

8. The drum of claim 1, wherein said shell has a shell diameter which varies between said shell upper end and said shell lower end.

9. The drum of claim 1, wherein said shell comprises a shell thickness of about 5 millimeters or less.

10. The drum of claim 1, wherein said shell comprises a shell thickness of between about 6 millimeters and about 8 millimeters.

11. The drum of claim 1, wherein said shell comprises a shell thickness of about 8 millimeters or more.

12. The drum of claim 1, further comprising a vent hole disposed in said shell to communicate between a shell interior space and an exterior space therearound.

13. The drum of claim 12, further comprising a grommet disposed about said vent hole.

14. The drum of claim 1, wherein said top head functions as the surface which a player strikes.

15. The drum of claim 14, wherein said player strikes said top head with a hand.

16. The drum of claim 14, wherein said player strikes said top head with an apparatus such as a drumstick, brush, mallet, or the like.

17. The drum of claim 1, wherein said top head comprises a rigid material.

18. The drum of claim 1, wherein said top head consists essentially of a rigid material.

19. The drum of claim 1, wherein said top head consists of a rigid material.

20. The drum of claim 1, wherein said top head consists essentially of wood.

21. The drum of claim 1, wherein said top head consists of wood.

22. The drum of claim 1, wherein said top head is substantially cylindrical.

23. The drum of claim 1, wherein said top head comprises a top head diameter of not less than about 10 inches.

24. The drum of claim 1, wherein said top head comprises a top head diameter of between about 10 inches and about 24 inches.

25. The drum of claim 1, wherein said top head comprises a top head thickness of not less than about 0.5 millimeters.

26. The drum of claim 1, wherein said top head comprises a top head thickness of between about 0.5 millimeters to about 10 millimeters.

27. The drum of claim 1, wherein said top head comprises a top head upper surface which is smooth.

28. The drum of claim 1, wherein said top head comprises a top head upper surface which is textured.

29. The drum of claim 1, wherein said top head is coupled to said shell upper end via one or more fasteners.

30. The drum of claim 29, wherein said fasteners comprise rods and lugs.

31. The drum of claim 1, wherein said bottom head comprises a stretchable material.

32. The drum of claim 1, wherein said bottom head is substantially cylindrical.

33. The drum of claim 1, wherein said bottom head comprises a bottom head diameter of not less than about 10 inches.

34. The drum of claim 1, wherein said bottom head comprises a bottom head diameter of between about 10 inches and about 24 inches.

35. The drum of claim 1, wherein said bottom head comprises a bottom head thickness of not greater than about 5 mils.

36. The drum of claim 1, wherein said bottom head comprises a bottom head thickness of between about 2 mils and about 5 mils.

37. The drum of claim 1, wherein said bottom head is coupled to said shell lower end via a hoop.

38. The drum of claim 1, wherein said snare wire is disposed within the perimeter of said bottom head.

39. The drum of claim 1, wherein said snare wire spans or extends diametrically across said bottom head.

40. The drum of claim 1, wherein said snare wire is tightenable and loosenable.

41. The drum of claim 1, wherein said snare wire disposes proximate a bottom head lower surface.

42. The drum of claim 1, wherein said snare wire disposes proximate a bottom head upper surface.

43. The drum of claim 1, further comprising a sound modifier disposed within said shell.

44. The drum of claim 43, wherein said sound modifier comprises an absorbent panel.

45. The drum of claim 1, further comprising a sound port disposed in said shell to communicate between a shell interior space and an exterior space therearound.

46. The drum of claim 1, further comprising a microphone disposed within a shell interior space of said shell.

47. The drum of claim 1, further comprising a support coupled to said drum, wherein said support facilitates supporting said drum on a support surface.

48. The drum of claim 1, further comprising a coupler coupled to said drum, wherein said coupler facilitates coupling of said drum to a player.

49. The drum of claim 1, further comprising a handle coupled to said drum, wherein said handle facilitates handling of said drum.

50. The drum of claim 1, further comprising a mount coupled to said drum, wherein said mount facilitates mounting an accessory on said drum.

51. A method of making an acoustic drum, comprising:
providing a shell comprising a shell depth extending between a shell upper end and an opposing shell lower end;
wherein said shell depth is not less than about 14 inches;
coupling a top head to said shell upper end;
wherein said top head comprises wood;
coupling a bottom head to said shell lower end; and
operably coupling at least one snare wire to said bottom head.

52. The method of claim 51, wherein said shell depth is between about 14 inches and about 36 inches.

53. The method of claim 51, wherein said shell depth is fixed.

54. The method of claim 51, wherein said shell depth is adjustable.

55. The method of claim 51, wherein said shell comprises an outer shell diameter of not less than about 10 inches.

56. The method of claim 51, wherein said shell comprises an outer shell diameter of between about 10 inches and about 24 inches.

57. The method of claim 51, wherein said shell is substantially cylindrical and comprises a substantially constant shell diameter between said shell upper end and said shell lower end.

58. The method of claim 51, wherein said shell has a shell diameter which varies between said shell upper end and said shell lower end.

59. The method of claim 51, wherein said shell comprises a shell thickness of about 5 millimeters or less.

60. The method of claim 51, wherein said shell comprises a shell thickness of between about 6 millimeters and about 8 millimeters.

61. The method of claim 51, wherein said shell comprises a shell thickness of about 8 millimeters or more.

62. The method of claim 51, further comprising disposing a vent hole in said shell to communicate between a shell interior space and an exterior space therearound.

63. The method of claim 62, further comprising disposing a grommet about said vent hole.

64. The method of claim 51, wherein said top head functions as the surface which a player strikes.

65. The method of claim 64, wherein said player strikes said top head with a hand.

66. The method of claim 64, wherein said player strikes said top head with an apparatus such as a drumstick, brush, mallet, or the like.

67. The method of claim 51, wherein said top head comprises a rigid material.

68. The method of claim 51, wherein said top head consists essentially of a rigid material.

69. The method of claim 51, wherein said top head consists of a rigid material.

70. The method of claim 51, wherein said top head consists essentially of wood.

71. The method of claim 51, wherein said top head consists of wood.

72. The method of claim 51, wherein said top head is substantially cylindrical.

73. The method of claim 51, wherein said top head comprises a top head diameter of not less than about 10 inches.

74. The method of claim 51, wherein said top head comprises a top head diameter of between about 10 inches and about 24 inches.

75. The method of claim 51, wherein said top head comprises a top head thickness of not less than about 0.5 millimeters.

76. The method of claim 51, wherein said top head comprises a top head thickness of between about 0.5 millimeters to about 10 millimeters.

77. The method of claim 51, wherein said top head comprises a top head upper surface which is smooth.

78. The method of claim 51, wherein said top head comprises a top head upper surface which is textured.

79. The method of claim 51, further comprising coupling said top head to said shell upper end via one or more fasteners.

80. The method of claim 79, wherein said fasteners comprise rods and lugs.

81. The method of claim 51, wherein said bottom head comprises a stretchable material.

82. The method of claim 51, wherein said bottom head is substantially cylindrical.

83. The method of claim 51, wherein said bottom head comprises a bottom head diameter of not less than about 10 inches.

84. The method of claim 51, wherein said bottom head comprises a bottom head diameter of between about 10 inches and about 24 inches.

85. The method of claim 51, wherein said bottom head comprises a bottom head thickness of not greater than about 5 mils.

86. The method of claim 51, wherein said bottom head comprises a bottom head thickness of between about 2 mils and about 5 mils.

87. The method of claim 51, further comprising coupling said bottom head to said shell lower end via a hoop.

88. The method of claim 51, further comprising disposing said snare wire within the perimeter of said bottom head.

89. The method of claim 51, wherein said snare wire spans or extends diametrically across said bottom head.

90. The method of claim 51, wherein said snare wire is tightenable and loosenable.

91. The method of claim 51, further comprising disposing said snare wire proximate a bottom head lower surface.

92. The method of claim 51, further comprising disposing said snare wire proximate a bottom head upper surface.

93. The method of claim 51, further comprising disposing a sound modifier within said shell.

94. The method of claim 93, wherein said sound modifier comprises an absorbent panel.

95. The method of claim 51, further comprising disposing a sound port in said shell to communicate between a shell interior space and an exterior space therearound.

96. The method of claim 51, further comprising disposing a microphone within a shell interior space of said shell.

97. The method of claim 51, further comprising coupling a support to said drum, wherein said support facilitates supporting said drum on a support surface.

98. The method of claim 51, further comprising coupling a coupler to said drum, wherein said coupler facilitates coupling of said drum to a player.

99. The method of claim 51, further comprising coupling a handle to said drum, wherein said handle facilitates handling of said drum.

100. The method of claim 51, further comprising coupling a mount to said drum, wherein said mount facilitates mounting an accessory on said drum.

101. A method of using an acoustic drum, comprising:
obtaining said drum comprising:
a shell comprising a shell depth extending between a shell upper end and an opposing shell lower end;
wherein said shell depth is not less than about 14 inches;
a top head coupled to said shell upper end;
wherein said top head comprises wood;
a bottom head coupled to said shell lower end; and
at least one snare wire operably coupled to said bottom head; and
striking said top head to produce sound.

102. The method of claim 101, further comprising striking said top head with at least one hand to produce sound.

103. The method of claim 101, further comprising striking said top head with an apparatus such as a drumstick, brush, mallet, or the like.

104. The method of claim 101, further comprising striking said top head to produce tonal qualities which differ from those of a conventional snare drum.
